(19) United States
(12) Patent Application Publication
(10) Pub. No.: US 2001/0041073 A1
(43) Pub. Date: Nov. 15, 2001

(54) Active aid for a handheld camera

(76) Inventors: Noam Sorek, Zichron Yaakov (IL); Ilia Vitsnudel, Even Yehuda (IL); Ron Fridental, Herzelia (IL)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/775,854

(22) Filed: Feb. 1, 2001

Related U.S. Application Data
(60) Provisional application No. 60/179,955, filed on Feb. 3, 2000.

(51) Int. Cl. G03B 17/48

(52) U.S. Cl. 396/431

(57) ABSTRACT

Apparatus for imaging an object, consisting of a projector, which is adapted to project and focus a marker pattern onto the object, and a hand-held camera, which is adapted to capture an image of a region defined by the marker pattern when the marker pattern is focussed onto the object.

### CROSS-REFERENCE TO RELATED APPLICATIONS

This application claims the benefit of U.S. Provisional Parent Application ND. 60/179,955, filed Feb. 3, 2000, which is incorporated herein by reference.

### FIELD OF THE INVENTION

The present invention relates generally to imaging systems, and specifically to aids for enabling such systems to form images correctly.

### BACKGROUND OF THE INVENTION

Finding a point at which a camera is in focus may be performed automatically, by a number of methods which are well known in the art. Typically, automatic focusing systems for cameras add significantly to the cost of the camera. In simpler cameras, focusing is usually performed manually or semi-manually, for example by an operator of the camera estimating the distance between the camera and the object being imaged, or by an operator aligning split sections of an image in a viewfinder.

Except for cameras comprising a “through-the-lens” viewfinder or the equivalent, the -viewfinder of a camera will of necessity introduce parallax effects, since the axis of the viewfinder system and the axis of the imaging system of the camera are not coincident. The parallax effects are relatively large for objects close to the camera. Methods for correcting parallax are known in the art. For example, a viewfinder may superimpose lines on a scene being viewed, the lines being utilized for close scenes. The lines give an operator using the viewfinder a general indication of parts of the close scene that will actually be imaged. Unfortunately, such lines give at best an inaccurate indication of the actual scene that will be imaged. Furthermore, having to use any type of viewfinder constrains an operator of the camera, since typically the head of the operator has to be positioned behind the camera, and the operator's eye has to be aligned with the viewfinder.

### SUMMARY OF THE INVENTION

It is an object of some aspects of the present invention to provide apparatus and methods for assisting a camera in accurately imaging an object.

It is a further object of some aspects of the present invention to provide apparatus and methods for assisting the operator of a camera to correctly focus and orient the camera without use of a viewfinder.

In preferred embodiments of the present invention, imaging apparatus comprises a hand-held camera and a projector. The projector projects and focuses a marker pattern onto an object, so that a plurality of points comprised in the marker pattern appear on the object in a known relationship to each other. The camera images the object including the plurality of points. The plurality of points are used in aligning the image, either manually by a user before the camera captures the image, or automatically by the camera, typically after the image has been captured.

In some preferred embodiments of the present invention, the projector is fixedly coupled to the hand-held camera. The projector projects a marker pattern which is pre-focussed to a predetermined distance. The pre-focussed distance is set to be substantially the same as the distance at which the camera is in focus. Furthermore, the marker pattern is most preferably oriented to outline the image that will be captured by the camera. A user orients the apparatus with respect to an object so that the marker pattern is focused on and outlines a region of the object which is to be imaged. The user is thus able to correctly and accurately position the camera before an image is recorded, without having to use a viewfinder of the camera.

In other preferred embodiments of the present invention, the projector is not mechanically coupled to the camera, and the axes of the projector and the camera are non-coincident. The projector projects and focuses the marker pattern onto an object, so that a plurality of points comprised in the marker pattern are in a known relationship to each other. The camera images the object, including the plurality of points. The points serve to define distortion that has been induced in the image because of misalignment between the camera and object. A central processing unit (CPU) uses the known relative positions of the plurality of points to correct the distortion of the image.

In some preferred embodiments of the present invention, the projector is combined with a sensor comprised in the camera.

In some preferred embodiments of the present invention, the projector comprises two beam generators fixedly coupled to the camera. The beam generators are aligned to produce beams which meet at a point which is in focus for the camera.

In some preferred embodiments of the present invention, the marker pattern of the imaging system is movable, responsive to commands from a CPU coupled to the projector. The CPU is also coupled to a sensor comprised in the camera and receives signals corresponding to the image on the sensor. The marker pattern is moved to one or more regions of the object, according to a characterization of the image performed by the CPU. Most preferably, the object comprises text, and the image characterization includes analysis of the text by the CPU.

There is therefore provided, according to a preferred embodiment of the present invention, apparatus for imaging an object, including:

a projector, which is adapted to project and focus a marker pattern onto the object; and

a hand-held camera, which is adapted to capture an image of a region defined by the marker pattern when the marker pattern is focussed onto the object.

Preferably, the projector is fixedly coupled to the hand-held camera.

Preferably, the marker pattern includes a marker-pattern depth-of-field, and the hand-held camera includes a camera depth-of-field, and the marker-pattern depth-of-field is a predetermined function of the camera depth-of-field.

Alternatively, the marker pattern includes a marker-pattern depth-of-field, and the hand-held camera includes a camera depth-of-field, and the marker-pattern depth-of-field is substantially the same as the camera depth-of-field

Preferably, the hand-held camera is included in a mobile telephone.

Preferably, the projector includes a mask and one or more illuminators which project an image of the mask onto the object so as to form the marker pattern thereon.

Further preferably, at least one of the mask and the one or more illuminators are adjustable in position so as to generate a different marker pattern responsive to the adjustment.

Preferably, the one or more illuminators include a plurality of illuminators, at least some of the plurality having different wavelengths.

Preferably the apparatus includes a central processing unit (CPU), and the marker pattern includes a plurality of elements having a predetermined relationship with each other, and the CPU corrects a distortion of the image of the region responsive to a captured image of the elements and the predetermined relationship.

Further preferably, the distortion includes at least one distortion chosen from a group of distortions comprising translation, scaling, rotation, shear, and perspective.

Preferably, a projector-optical-axis of the projector is substantially similar in orientation to a camera-optical-axis of the camera.

Alternatively, a projector-optical-axis of the projector is substantially different in orientation from a camera-optical-axis of the camera.

Preferably, the projector includes one or more illuminators, and the hand-held camera includes an imaging sensor, and the illuminators are fixedly coupled to the imaging sensor so as to form the marker pattern at a conjugate plane of the sensor.

Preferably, the one or more illuminators include respective one or more mirrors which are implemented with the imaging sensor as one monolithic element, and a source which illuminates the one or more mirrors.

Preferably, the one or more mirrors include diffractive optics.

Further preferably, the one or more illuminators include respective one or more holes which are implemented within the sensor, and a source and a light guide which is adapted to direct light from the source through the one or more holes.

Preferably, the apparatus includes a central processing unit (CPU), wherein the CPU is adapted to measure at least one parameter in a first group of parameters including an intensity of the marker pattern and an intensity of the image, and to alter an intensity of the one or more illuminators responsive to at least one parameter of a second group of parameters including a distance of the object from the camera, the measured marker pattern intensity, and the measured image intensity.

Preferably, the apparatus includes a CPU which is adapted to analyze a position of an image of the marker pattern produced in the hand-held camera, and to generate a sensory signal to a user of the apparatus responsive to the analyzed position of the marker pattern image relative to the image of the region.

Preferably, the projector includes a first and a second optical beam generator, and the marker pattern includes a respective first and second image of each beam on the object, and the marker pattern is in focus when the first and second images substantially coincide.

Further preferably, a first wavelength of the first beam is substantially different from a second wavelength of the second beam.

Further preferably, a first orientation of the first beam is substantially different from a second orientation of the second beam.

Preferably, the projector includes a beam director which is adapted to vary a position of the marker pattern, wherein the hand-held camera includes an imaging sensor and a CPU which is coupled to the sensor and the beam director, so that the CPU varies the position of the marker pattern responsive to a characteristic of the image of the region.

Further preferably, the region includes text, and the CPU is adapted to analyze the image of the region to characterize the text, and the characteristic of the image includes a text characteristic.

Preferably, the region includes a portion of the object which is related to the marker pattern by a predetermined geometrical relationship.

Further preferably, the region is substantially framed by the marker pattern.

There is further provided, according to a preferred embodiment of the present invention, a method for imaging an object, including:

projecting a marker pattern with a projector;

focussing the marker pattern onto the object;

defining a region of the object by the focussed marker pattern; and

capturing an image of the region with a hand-held camera.

Preferably, the method includes fixedly coupling the projector to the hand-held camera.

Preferably, focussing the marker pattern includes focussing the marker pattern responsive to a marker-pattern depth-of-field, wherein capturing the image includes focussing the camera on the region within a camera depth-of-field, and wherein the marker-pattern depth-of-field is a predetermined function of the camera depth-of-field.

Preferably, focussing the marker pattern includes focussing the marker pattern within a marker-pattern depth-of-field, wherein capturing the image includes focussing the camera on the region within a camera depth-of-field, and wherein the marker-pattern depth-of-field is substantially the same as the camera depth-of-field.

Preferably, the hand-held camera is included in a mobile telephone.

Preferably, the projector includes a mask and one or more illuminators and projecting the marker pattern includes projecting an image of the mask onto the object so as to form the marker pattern thereon.

Preferably, projecting the marker pattern includes adjusting a position of at least one of the mask and the one or more illuminators so as to generate a different marker pattern responsive to the adjustment.

Preferably, projecting the marker pattern includes projecting a plurality of elements having a predetermined relationship with each other, and capturing the image includes correcting a distortion of the image of the region utilizing a central processing unit (CPU) responsive to a captured image of the elements and the predetermined relationship.

Further preferably, the distortion includes at least one distortion chosen from a group of distortions including translation, scaling, rotation, shear, and perspective.

Preferably, the projector includes one or more illuminators, wherein the hand-held camera includes an imaging sensor, and wherein projecting the marker pattern includes fixedly coupling the illuminators to the imaging sensor, and wherein focussing the marker pattern includes focussing the pattern at a conjugate plane of the sensor.

Preferably, the one or more illuminators include respective one or more mirrors which are implemented with the imaging sensor as one monolithic element, and wherein projecting the marker pattern includes illuminating the one or more mirrors.

Further preferably, the one or more mirrors include diffractive optics.

Preferably, the one or more illuminators include respective one or more holes which are implemented within the sensor and a source and a light guide, and projecting the marker pattern includes directing light from the source via the light guide through the one or more holes.

Preferably, the method includes measuring at least one parameter in a first group of parameters including an intensity of the marker pattern and an intensity of the image, and altering an intensity of the one or more illuminators responsive to at least one parameter of a second group of parameters comprising a distance of the object from the camera, the measured marker pattern intensity, and the measured image intensity.

Preferably, the method includes analyzing a position of an image of the marker pattern produced in the hand- held camera, and generating a sensory signal to a user of the apparatus responsive to the analyzed position of the marker pattern image relative to the image of the region.

Preferably, the projector includes a first and a second optical beam generator, and the marker pattern includes a respective first and second image of each beam on the object, and focussing the marker pattern includes aligning the first and second images to substantially coincide.

Preferably, the camera includes a CPU, and capturing the image includes determining a characteristic of the image of the region with the CPU, and projecting the marker pattern includes varying a position of the marker pattern with a beam director included in the projector responsive to a signal from the CPU and the characteristic of the image.

Further preferably, determining the characteristic of the image includes:

analyzing the image of the region to recover text therein; and

determining a text characteristic of the text.

Preferably, defining the region includes relating a portion of the object to the marker pattern by a predetermined geometrical relationship.

Further preferably, relating a portion of the object includes framing the portion by the marker pattern.

The present invention will be more fully understood from the following detailed description of the preferred embodiments thereof, taken together with the drawings, in which:

### BRIEF DESCRIPTION OF THE DRAWINGS

FIG. 1A is a schematic diagram of an imaging system, according to a preferred embodiment of the present invention;

FIG. 1B is a schematic diagram showing the system of FIG. 1A in use, according to a preferred embodiment of the present invention

FIG. 2 is a schematic diagram showing details of a projector comprised in the system of FIG. 1A, according to a preferred embodiment of the present invention;

FIG. 3 is a schematic diagram of a system for automatic distortion correction, according to an alternative preferred embodiment of the present invention;

FIG. 4 is a schematic diagram of an integral projector and sensor system, according to a further alternative embodiment of the present invention;

FIG. 5 is a schematic diagram of an alternative integral projector and sensor system, according to a preferred embodiment of the present invention;

FIG. 6 is a schematic diagram of a further alternative integral projector and sensor system, according to a preferred embodiment of the present invention;

FIG. 7 is a schematic diagram of an alternative imaging system, according to a preferred embodiment of the present invention; and

FIG. 8 is a schematic diagram of a further alternative imaging system, according to a preferred embodiment of the present invention.

### DETAILED DESCRIPTION OF PREFERRED EMBODIMENTS

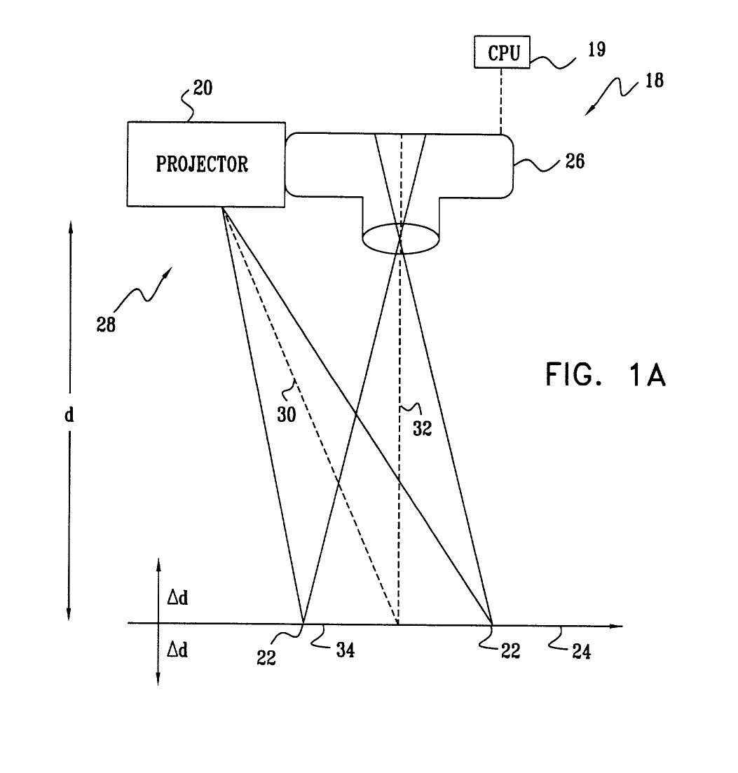

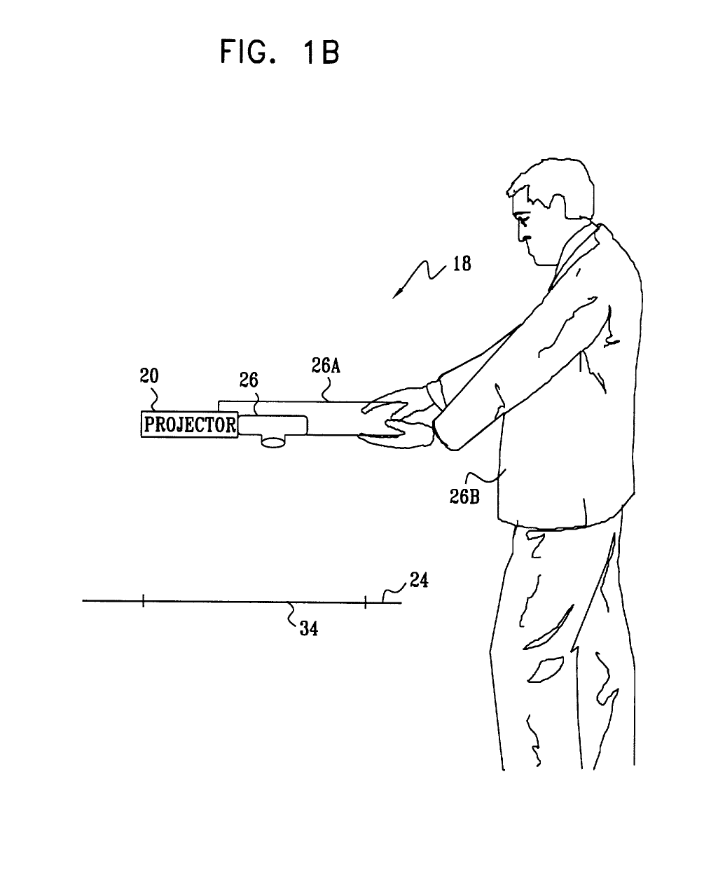

Reference is now made to FIG. 1A, which is a schematic diagram of an imaging system 18, according to a preferred embodiment of the present invention. System 18 comprises a projector 20 which images a marker pattern 22 onto an object 24, and a hand-held camera 26 which in turn images a section 34 of the object outlined by the marker pattern. Projector 20 is fixedly coupled to hand-held camera 26 and comprises an optical system 28 which projects marker pattern 22. Marker pattern 22 is in focus on object 24 when the object is at a specific distance “d” from projector 20. The specific distance d corresponds to the distance from camera 26 at which the camera is in focus. Most preferably, camera 26 comprises a focus adjustment which is set to d and has a depth-of-field of 2Δd, so that object 24 is in focus when the object is distant d±Δd from the camera.

Preferably, a depth-of-field wherein markers 22 are in focus is set to be from approximately (d−Δd) to infinity. In this case, a position where object 24 is substantially in focus may be found by varying the position of the object with respect to camera 26 and projector 20, and observing at which position markers 22 change from being out-of-focus to being in-focus, or vice versa. For example, if object 24 is initially positioned a long distance from camera 26, i.e., effectively at infinity, so that markers 22 are in focus, the distance is reduced until the markers go out-of-focus, at which position object 24 is substantially in-focus. If object 24 is initially positioned close to the camera, so that markers 22 are out of focus, the distance is increased until the markers come in-focus, at which position object 24 is again substantially in-focus. Those skilled in the art will appreciate that setting markers 22 to have the depth-of-field as described above is relatively simple to implement.

Alternatively, optical system 28 is implemented with a depth-of-field generally the same as the depth-of-field of camera 26, so that marker pattern 22 is in focus on object 24 when the object is distant d±Δd from the system.

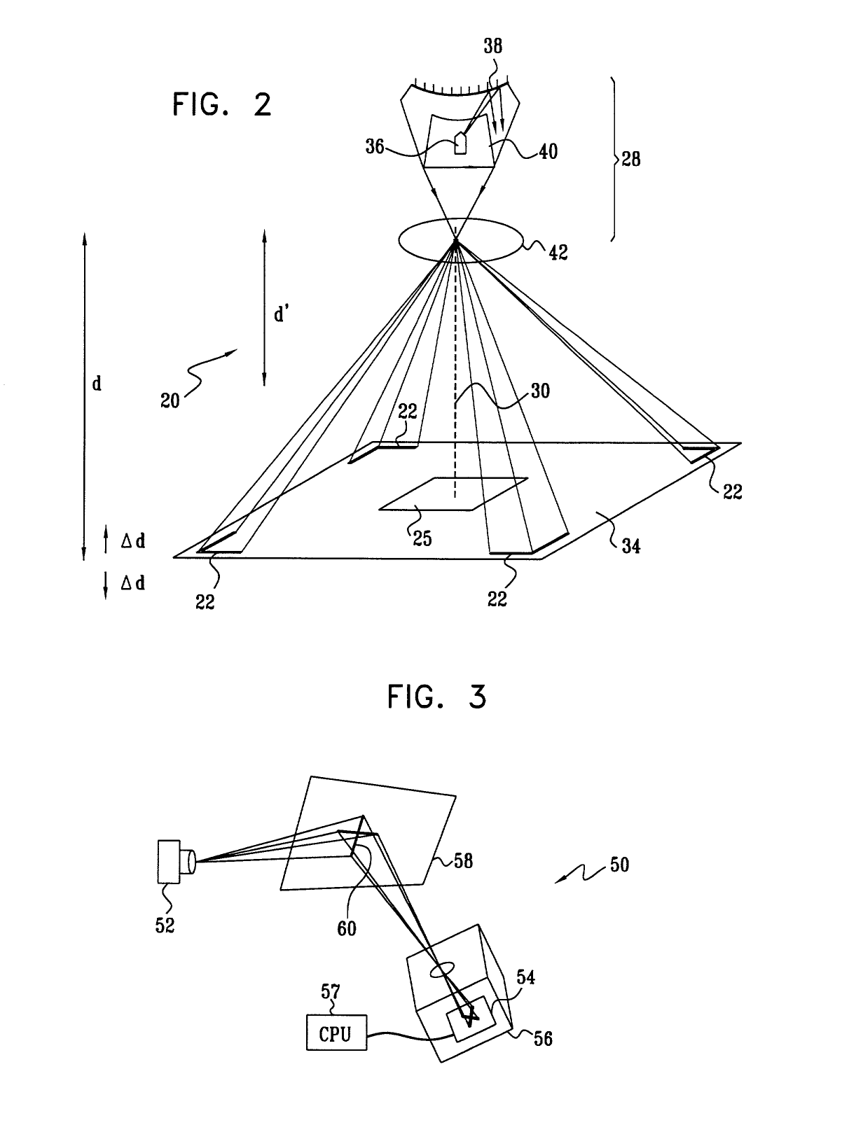

Preferably, optical system 28 has an optical axis 30, which intersects an optical axis 32 of camera 26 substantially at object 24. Alternatively, axis 30 and axis 32 do not intersect, and marker pattern 22 is generated by an “offset ” arrangement, as described in more detail below with respect to FIG. 2. In either case, when marker pattern 22 is focussed on object 24, preferably by one of the methods described hereinabove, an image of the object will be in focus for hand-held camera 26.

FIG. 1B is a schematic diagram showing system 18 in use, according to a preferred embodiment of the present invention. Hand-held camera 26 is most preferably incorporated in another hand-held device 26 A, such as a mobile telephone. An example of a mobile telephone comprising a hand-held camera is the SCH V200 digital camera phone produced by Samsung Electronics Co. Ltd., of Tokyo, Japan. Projector 20 is fixedly coupled to device 26 A, and thus to camera 26 by any convenient mechanical method known in the art. A user 26 B holds device 26 A, points the device at object 24, and moves the device so that marker pattern 22 is in focus and delineates region 34. User 26 B then operates camera 26 to generate an image of region 34.

In some preferred embodiments of the present invention, system 18 comprises a central processing unit (CPU) 19, coupled to camera 26. Preferably, CPU 19 is an industry-standard processing unit which is integrated within hand-held camera 26. Alternatively, CPU 19 is implemented as a separate unit from the camera. CPU 19 is programmed to recognize when camera 26 is substantially correctly focussed and oriented on object 24, by analyzing positions of images of marker pattern 22 produced in the camera. Most preferably, CPU 19 then operates the camera automatically, to capture an image of object 24. Alternatively or additionally, CPU 19 responds by indicating to user 26 B, using any form of sensory indication known in the art, such as an audible beep, that the system is correctly focussed and oriented.

FIG. 2 is a schematic diagram showing details of projector 20 and marker pattern 22, according to a preferred embodiment of the present invention. Marker pattern 22 most preferably comprises four “L-shaped ” sections which enclose section 34 of object 24. Optical system 28 comprises a light emitting diode (LED) 36 which acts as an illuminator of a convex mirror 38. Mirror 38 reflects light from LED 36 through a mask 40 comprising four L-shaped openings, and light passing through these openings is incident on a lens 42. Lens 42 images the L-shaped openings of mask 40 onto object 24 as marker pattern 22. To operate projector 20, LED 36 is energized, and the projector and attached camera 26 are moved into position relative to object 24.

It will be appreciated that implementing system 28 using a LED is significantly safer than using a laser or laser diode as a light source in the system. Also, using projector 20 as described hereinabove provides simple and intuitive feedback to a user of the projector for focusing and orienting camera 26 correctly relative to object 24, in substantially one operation, without having to use a viewfinder which may be comprised in camera 26. Furthermore, in some preferred embodiments of the present invention optical system 28 is able to focus marker pattern 22 to different distances d, and corresponding different sections 34 of object 24. Methods for implementing such an optical system, such as adjusting positions of mask 40, LED 36, and/or lens 42, will be apparent to those skilled in the art. Such an optical system preferably comprises one or more LEDs which emit different wavelengths for the different distances d so that the respective different marker patterns can be easily distinguished. Further preferably, for each different distance d, a different mask 40 is implemented and/or the LEDs are positioned differently. Alternatively, mask 40 is positioned differently for the different distances d.

In some preferred embodiments of the present invention, system 28 is implemented for a specific size of object 24. For example, if object 24 comprises a standard size business card or a standard size sheet of paper, mask 40, and/or other components comprised in system 28, is set so that marker pattern 22 respectively outlines the card or the paper.

It will be appreciated that if it is required to image a region 25 of object 24, different from region 34, marker pattern 22 can most preferably be focused to a distance d′, corresponding to region 25. If region 25 is smaller than region 34, so that d′ is smaller than d, the resolution of region 25 will be correspondingly increased. Furthermore, mask 40 and/or other optical elements of projector 28 described hereinabove may be offset from axis 30 of the projector, so that marker pattern 22 is formed in a desired orientation on object 34, regardless of a relationship between axis 30 and axis 32.

It will be understood that while marker pattern 22 may be set to frame a region of object 24 which is imaged, this is not a necessary condition for the relation between the marker pattern and the region. Rather, the region defined by marker pattern 22 is any portion of object 24 which is related geometrically in a predetermined manner to the marker pattern. Marker pattern 22 is used by user 26 B to assist the user to position camera 26. For example, marker pattern 22 may be a pattern intended to be formed on the middle of a document, substantially the whole of which document is to be imaged, and system 18 is set up so that this condition holds. In this case, once user 26 B has positioned marker pattern 22 to be substantially at the center of the document, camera 26 correctly images the document.

FIG. 3 is a schematic diagram of a system 50 for automatic distortion correction, according to an alternative preferred embodiment of the present invention. System 50 comprises a projector 52, wherein apart from the differences described below, the operation of projector 52 is generally similar to that of projector 20 (FIGS. 1A, 1B, and 2 ). Preferably, in contrast to projector 20, projector 52 is not fixedly coupled to a camera. Alternatively, projector 52 is fixedly coupled to a camera, but the axes of the projector and the camera are significantly different in orientation. System 50 is used to correct distortion effects generated when a sensor 54 in a hand-held camera 56 forms an image of an object 58. Hand-held camera 56 is generally similar, except for differences described herein, to camera 26. Such distortion effects are well known in the art, being caused, for example, by perspective distortion and/or the plane of object 58 not being parallel to the plane of sensor 54.

Projector 52 is preferably aligned with object 58 so that, when in focus, a marker pattern 60 having known dimensions is projected onto the object. Alternatively, elements within marker pattern 60 have known relationships to each other. Assume that the coordinates of a point in the image formed on sensor 54 are (x, y). The image comprises distortion effects which can be considered to be generated by one or more of the transformations translation, scaling, rotation, and shear. Coordinates (x′, y′) for a corrected point are given by an equation:

$$[ 89 ] \\ ( \begin{matrix}{x}^{′} \\ {y}^{′}\end{matrix} ) = ( \begin{matrix}a & b \\ c & d\end{matrix} ) ( \begin{matrix}x \\ y\end{matrix} ) + ( \begin{matrix}e \\ f\end{matrix} ) \qquad ( 1 )$$

wherein a, b, c, d, e, and f are transformation coefficients which are functions of the relationships between the marker pattern, the plane of object 58, and the plane of sensor 54. Thus, the six coefficients a, b, c, d, e, and f may be determined if three or more values of (x, y) and corresponding values (x′, y′) are known.

In general, for a number of known fiducial points (x₁, Y₁), (x₂, Y₂), (x₃), . . . and corrected points (x₁′, Y₁′, ), (x₂′, Y₂′), (x₃′, y₃′), . . . equation (1) can be rewritten:

$$[ 92 ] \\ {X}^{′} = ( \begin{matrix}X & Y & I\end{matrix} ) ( \begin{matrix}a \\ b \\ e\end{matrix} ) , {Y}^{′} = ( \begin{matrix}X & Y & I\end{matrix} ) ( \begin{matrix}c \\ d \\ f\end{matrix} ) \\ [ 93 ] \\ wherein X represents the vector ( \begin{matrix}{x}_{1} \\ {x}_{2} \\ {x}_{3} \\ ⋮\end{matrix} ) \qquad ( 2 )$$

$$\text{[94] Y represents the vector} ( \begin{matrix}{y}_{1} \\ {y}_{2} \\ {y}_{3} \\ ⋮\end{matrix} )$$

$$\text{[95] I represents the unit vector} ( \begin{matrix}1 \\ 1 \\ 1 \\ ⋮\end{matrix} )$$

$$\text{[96]X' represents the vector} ( \begin{matrix}{x}_{1}^{′} \\ {x}_{2}^{′} \\ {x}_{3}^{′} \\ ⋮\end{matrix} )$$

$$\text{[97] Y' represents the vector} ( \begin{matrix}{x}_{1} \\ {x}_{2} \\ {x}_{3} \\ ⋮\end{matrix} ) , and$$

$$\text{[98] A represents the matrix} ( \begin{matrix}{x}_{1} & {y}_{1} & 1 \\ {x}_{2} & {y}_{2} & 1 \\ {x}_{3} & {y}_{3} & 1 \\ ⋮ & ⋮ & ⋮\end{matrix} ) = ( X Y I )$$

Equations (2) can be rewritten as equations:

X′=A·abe^{t},Y′=A·cdf^{t} (3)

wherein n^{t} represents the transform of n.

>From equations (3), general solutions for coefficients a, b, c, d, e, and f can be written as equations:

abe^{t}=(A^{t}·A)⁻¹·A^{t}·X′cdf^{t}=(A^{t}·A)⁻¹·A^{t}·X′ (4)

In preferred embodiments of the present invention, marker pattern 60 is substantially similar to marker pattern 22 described hereinabove, so that pattern 60 comprises four points having known dimensions, corresponding to known values of (x′, y′). These known values, together with four respective values (x, y) of corresponding pixel signals measured by sensor 54, are used to calculate values for coefficients a, b, c, d, e, and f using equations (4). The calculated values are then applied to the remaining pixel signals from sensor 54 in order to generate an image free of distortion effects.

System 50 comprises a central processing unit (CPU) 57 which is coupled to sensor 54, receiving pixel signals therefrom, and which performs the calculations described with reference to equation (4). CPU 57 is preferably comprised in hand-held camera 56. Alternatively, CPU 57 is separate from camera 56, in which case data corresponding to the image formed by the camera is transferred to the CPU by one of the methods known in the art for transferring data.

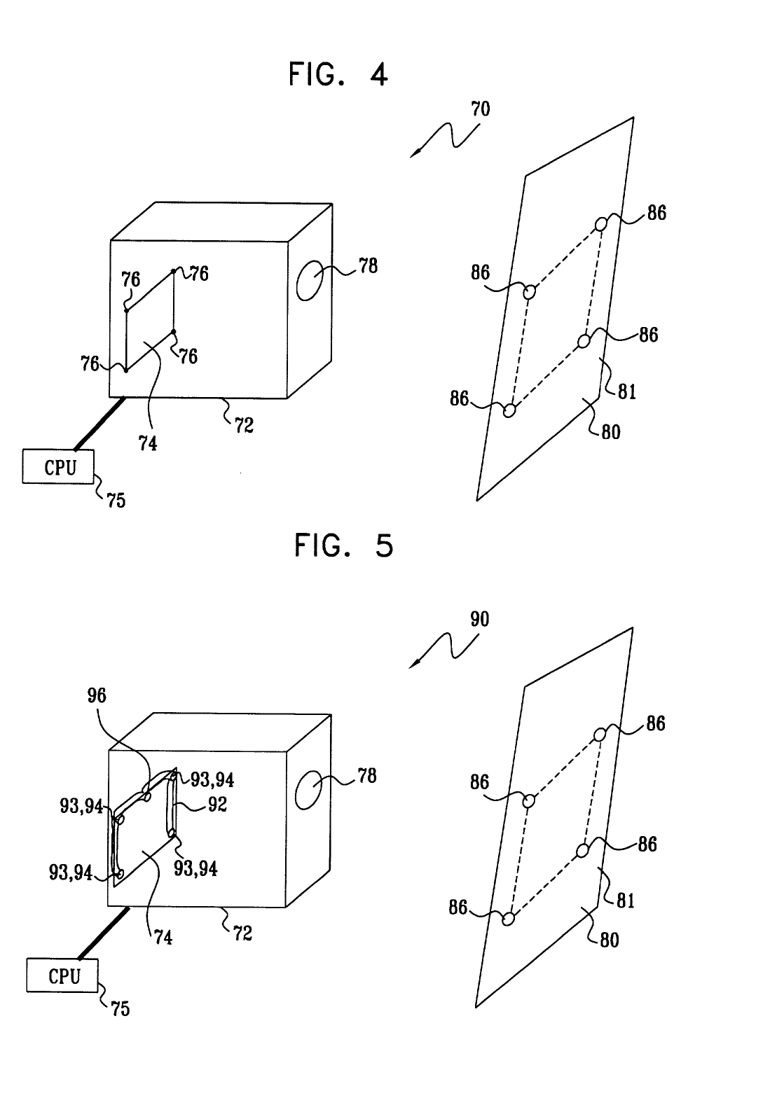

FIG. 4 is a schematic diagram of an integral projector and sensor system 70, according to a further alternative embodiment of the present invention. System 70 comprises a hand-held camera 72 having a sensor 74, which may be any industry-standard imaging sensor. Most preferably, a plurality of LEDs 76 acting as illuminators are mounted at the corners of sensor 74, in substantially the same plane as the sensor. Preferably, LEDs 76 are mounted on sensor 74 so as to reduce the effective area of the sensor at little as possible. Alternatively, LEDs 76 are mounted just outside the effective area of the sensor.

When LEDs 76 are operated, they are imaged by a lens 78 of camera 72 at a conjugate plane 80 of sensor 74, forming markers 86 at the plane. It will be appreciated that plane 80 may be found in practice by operating LEDs 76, and moving an object 81 to be imaged on sensor 74 until markers 86 are substantially in focus, at which position the object will automatically be in focus on the sensor.

FIG. 5 is a schematic diagram of an alternative projector and sensor system 90, according to a preferred embodiment of the present invention. Apart from the differences described below, the operation of system 90 is generally similar to that of system 70 (FIG. 4), so that elements indicated by the same reference numerals in both systems 90 and 70 are generally similar in construction and in operation. Instead of mounting a plurality of LEDs 76 at the corners of sensor 74, the sensor is mounted adjacent to a light guide 92, which has exits 94 at corresponding holes 93 of the sensor. Light guide 92 comprises one or more LEDs 96, and the light guide directs the light from LEDs 96 to exits 94, so that the light guide and LEDs 96 function generally as LEDs 76.

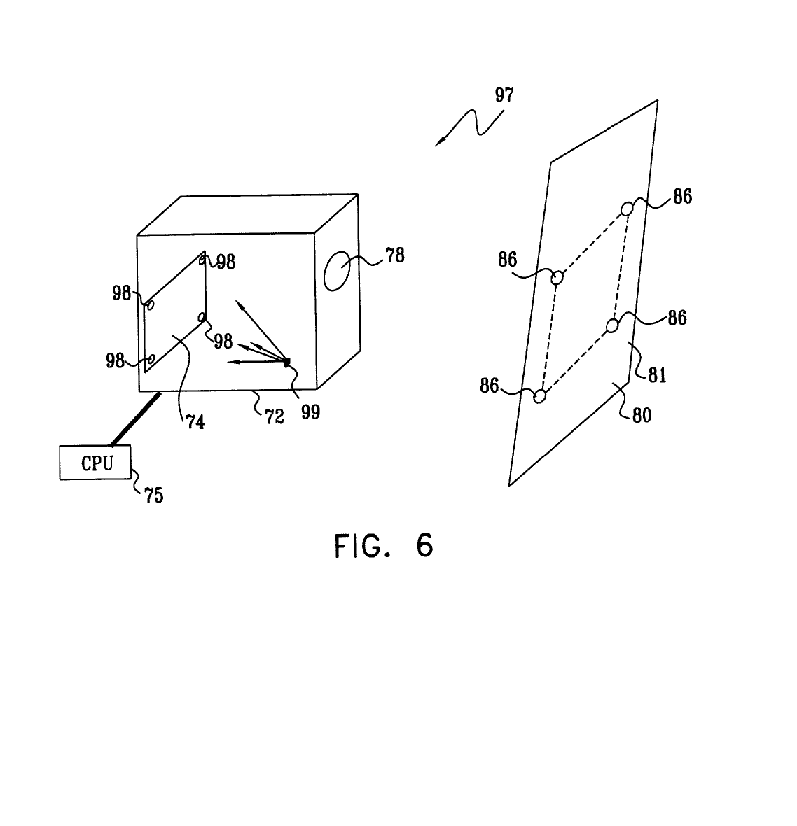

FIG. 6 is a schematic diagram of a further alternative projector and sensor system 97, according to a preferred embodiment of the present invention. Apart from the differences described below, the operation of system 97 is generally similar to that of system 70 (FIG. 4), so that elements indicated by the same reference numerals in both systems 97 and 70 are generally similar in construction and in operation. Instead of mounting a plurality of LEDs 76 at the corners of sensor 74, the sensor comprises one or more mirrors 98 illuminated by a light source 99. Most preferably, light source 99 is adapted to illuminate substantially only mirrors 98, by methods known in the art. Mirrors 98 are adjusted to reflect light from source 99 through lens 78 so as to form markers 86, as described above with reference to FIG. 4.

It will be appreciated that mirrors 97 may be formed as diffractive optic elements on a substrate of sensor 74, so enabling a predetermined pattern to be generated by each mirror 97. Furthermore, implementing sensor 74 and one or more mirrors 97 on the substrate enables the sensor and mirrors to be implemented as one monolithic element.

In some preferred embodiments of the present invention, a CPU 75 is coupled to camera 72 of system 70, system 90, and/or system 97. CPU 75 is most preferably programmed to recognize when markers 86 formed by LEDs 76 (system 70 ), exits 94 (system 90 ), or mirrors 98 (system 97) are substantially correctly focussed and oriented on sensor 74, by analyzing the image produced by the markers on the sensor. In this case, CPU 75 most preferably responds, for example by signaling to a user of system 70 or system 90 that the system is correctly focussed and oriented. The signal may take the form of any sensory signal, such as a beep and/or a light flashing. Alternatively or additionally, when CPU 75 determines that its system is correctly focussed and oriented, it responds by causing camera 72 to automatically capture the image formed on sensor 74.

Most preferably, CPU 75 is implemented to control the intensity of light emitted by illuminators 76, LEDs 96, and source 99, in systems 70, 90, and 97, respectively. Preferably, the intensity is controlled by the CPU responsive to the focussed distance of object 81 at which the respective system is set. Controlling the emitted light intensity according to the focussed distance enables power consumption to be reduced, and enables safer operation, without adversely affecting operation of the system.

Furthermore, CPU 75 is most preferably implemented so as to measure the intensity of images of markers 86 produced on sensor 74. Using the measured intensity of the images of the markers, optionally with other intensity measurements of the image formed on sensor 74, CPU 75 then controls the intensity of the light emitted by illuminators 76, LEDs 96, and source 99. For example, when the ambient environment is relatively dark, and/or when there is a high contrast between markers 86 and object 81, as CPU 75 can determine from analysis of the image formed on sensor 74, the CPU most preferably reduces the intensity of the light emitted.

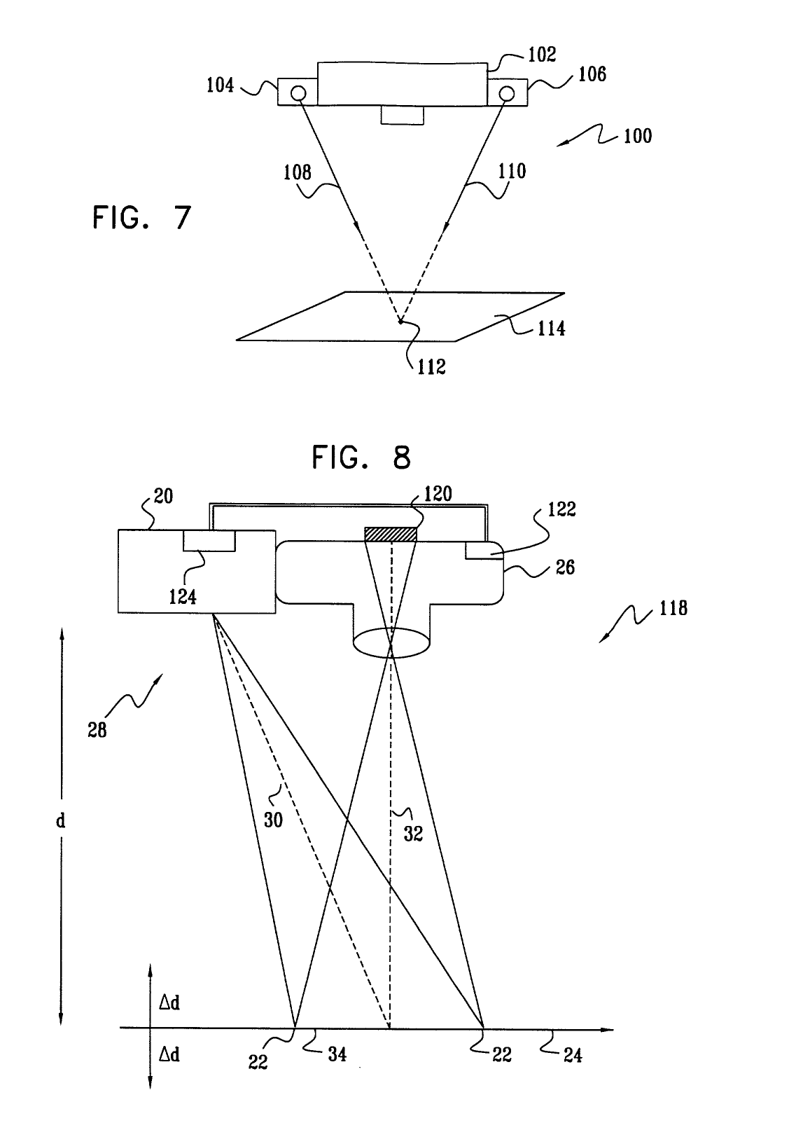

FIG. 7 is a schematic diagram of an alternative imaging system 100, according to a preferred embodiment of the present invention. System 100 comprises a hand-held camera 102 and two optical beam generators 104, 106. Beam generators 104 and 106 are implemented so as to each project respective relatively narrow substantially non-divergent beams 108 and 110 of visible light. Beam generators 104 and 106 are each preferably implemented from a LED and a focussing lens. Alternatively, beam generators 104 and 106 are implemented using lasers, or other means known in the art for generating non-divergent beams. In some preferred embodiments of the present invention, generators 104 and 106 project beams 108, 110 of different colors.

Beam generators 104 and 106 are fixedly coupled to hand-held camera 102 so that beams 108 and 110 intersect at a point 112, corresponding to a position where camera 102 is in focus. In order to focus camera 102 onto an object 114, a user of system 100 moves the camera and its coupled generators until point 112 is visible on the object.

FIG. 8 is a schematic diagram of an alternative imaging system 118, according to a preferred embodiment of the present invention. Apart from the differences described below, the operation of system 118 is generally similar to that of system 18 (FIGS. 1A, 1B, and 2 ), so that elements indicated by the same reference numerals in both systems 118 and 18 are generally identical in construction and in operation. System 118 comprises a CPU 122 which is used to control projector 20. Preferably, CPU 122 is an industry-standard processing unit which is integrated within hand-held camera 26. Alternatively, CPU 122 is implemented as a separate unit from the camera. Projector 20 comprises a beam director 124. Beam director 124 comprises any system known in the art which is able to vary the position of markers 22 on object 24, such as, for example, a system of movable micro-mirrors and/or a plurality of LEDs whose orientation is variable. Beam director 124 is coupled to and controlled by CPU 122, so that the position of markers 22 on object 24 is controlled by the CPU.

Camera 26 comprises a sensor 120, substantially similar to sensor 74 described above with reference to FIG. 4, which is coupled to CPU 122. In operating system 118, an image of region 34 most preferably comprising typewritten text is formed on sensor 120, and CPU 122 analyzes the image, for example using optical character recognition (OCR), to recover and/or characterize the text. Alternatively, region 34 comprises hand-written text. Depending on the characterization, CPU conveys signals to beam director 124 to vary the positions of markers 22. For example, system 118 may be implemented to detect spelling errors in text within region 34, by CPU 122 characterizing then analyzing the text. Misspelled words are highlighted by markers 22 being moved under control of CPU 122 and beam director 124. Other applications of system 118, wherein an image of an object is formed and analyzed, and wherein a section of the object is highlighted responsive to the analysis, will be apparent to those skilled in the art.

Returning to FIG. 1A and FIG. 2, it will be appreciated that marker pattern 22 may be used for other purposes apart from focusing object 24. For example, pattern 22 may be used to designate a region of interest within object 24. Alternatively or additionally, pattern 22 may be used to mark specific text within object 24, typically when the object is a document containing text. Marker pattern 22 does not necessarily have to be in the form shown in FIGS. 1A and 2. For example marker pattern 22 may comprise a long thin rectangle which can be used to designate a line of text. Alternatively, marker pattern 22 comprises a line which is used to select or emphasize text within object 24 or a particular region of the object. In some preferred embodiments of the present invention, marker 22 is used as an illuminating device.

When marker 22 is used to select text, camera 26 may be used to perform further operations on the selected text. For example a Universal Resource Locator (URL) address may be extracted from the text. Alternatively, the text may be processed through an OCR system and/or conveyed to another device such as a device wherein addresses are stored.

It will be appreciated that the preferred embodiments described above are cited by way of example, and that the present invention is not limited to what has been particularly shown and described hereinabove.

Rather, the scope of the present invention includes both combinations and subcombinations of the various features described hereinabove, as well as variations and modifications thereof which would occur to persons skilled in the art upon reading the foregoing description and which are not disclosed in the prior art.

1. Apparatus for imaging an object, comprising:
a projector, which is adapted to project and focus a marker pattern onto the object; and
a hand-held camera, which is adapted to capture an image of a region defined by the marker pattern when the marker pattern is focussed onto the object.

2. Apparatus according to claim 1, wherein the projector is fixedly coupled to the hand-held camera.

3. Apparatus according to claim 1, wherein the marker pattern comprises a marker-pattern depth-of-field, and wherein the hand-held camera comprises a camera depth-of-field, and wherein the marker-pattern depth-of-field is a predetermined function of the camera depth-of-field.

4. Apparatus according to claim 1, wherein the marker pattern comprises a marker-pattern depth-of-field, and wherein the hand-held camera comprises a camera depth-of-field, and wherein the marker-pattern depth-of-field is substantially the same as the camera depth-of-field.

5. Apparatus according to claim 1, wherein the hand-held camera is comprised in a mobile telephone.

6. Apparatus according to claim 1, wherein the projector comprises a mask and one or more illuminators which project an image of the mask onto the object so as to form the marker pattern thereon.

7. Apparatus according to claim 6, wherein at least one of the mask and the one or more illuminators are adjustable in position so as to generate a different marker pattern responsive to the adjustment.

8. Apparatus according to claim 6, wherein the one or more illuminators comprise a plurality of illuminators, at least some of the plurality having different wavelengths.

9. Apparatus according to claim 1, and comprising a central processing unit (CPU), and wherein the marker pattern comprises a plurality of elements having a predetermined relationship with each other, and wherein the CPU corrects a distortion of the image of the region responsive to a captured image of the elements and the predetermined relationship.

10. Apparatus according to claim 9, wherein the distortion comprises at least one distortion chosen from a group of distortions comprising translation, scaling, rotation, shear, and perspective.

11. Apparatus according to claim 1, wherein a projector-optical-axis of the projector is substantially similar in orientation to a camera-optical-axis of the camera.

12. Apparatus according to claim 1, wherein a projector-optical-axis of the projector is substantially different in orientation from a camera-optical-axis of the camera.

13. Apparatus according to claim 1, wherein the projector comprises one or more illuminators, and wherein the hand-held camera comprises an imaging sensor, and wherein the illuminators are fixedly coupled to the imaging sensor so as to form the marker pattern at a conjugate plane of the sensor.

14. Apparatus according to claim 13, wherein the one or more illuminators comprise respective one or more mirrors which are implemented with the imaging sensor as one monolithic element, and a source which illuminates the one or more mirrors.

15. Apparatus according to claim 14, wherein the one or more mirrors comprise diffractive optics.

16. Apparatus according to claim 13, wherein the one or more illuminators comprise respective one or more holes which are implemented within the sensor, and a source and a light guide which is adapted to direct light from the source through the one or more holes.

17. Apparatus according to claim 13, and comprising a central processing unit (CPU), wherein the CPU is adapted to measure at least one parameter in a first group of parameters comprising an intensity of the marker pattern and an intensity of the image, and to alter an intensity of the one or more illuminators responsive to at least one parameter of a second group of parameters comprising a distance of the object from the camera, the measured marker pattern intensity, and the measured image intensity.

18. Apparatus according to claim 1, and comprising a CPU which is adapted to analyze a position of an image of the marker pattern produced in the hand-held camera, and to generate a sensory signal to a user of the apparatus responsive to the analyzed position of the marker pattern image relative to the image of the region.

19. Apparatus according to claim 1, wherein the projector comprises a first and a second optical beam generator, and wherein the marker pattern comprises a respective first and second image of each beam on the object, and wherein the marker pattern is in focus when the first and second images substantially coincide.

20. Apparatus according to claim 19, wherein a first wavelength of the first beam is substantially different from a second wavelength of the second beam.

21. Apparatus according to claim 19, wherein a first orientation of the first beam is substantially different from a second orientation of the second beam.

22. Apparatus according to claim 1, wherein the projector comprises a beam director which is adapted to vary a position of the marker pattern, wherein the hand-held camera comprises an imaging sensor and a CPU which is coupled to the sensor and the beam director, so that the CPU varies the position of the marker pattern responsive to a characteristic of the image of the region.

23. Apparatus according to claim 22, wherein the region comprises text, and wherein the CPU is adapted to analyze the image of the region to characterize the text, and wherein the characteristic of the image comprises a text characteristic.

24. Apparatus according to claim 1, wherein the region comprises a portion of the object which is related to the marker pattern by a predetermined geometrical relationship.

25. Apparatus according to claim 24, wherein the region is substantially framed by the marker pattern.

26. A method for imaging an object, comprising:
projecting a marker pattern with a projector;
focussing the marker pattern onto the object;
defining a region of the object by the focussed marker pattern; and
capturing an image of the region with a hand-held camera.

27. A method according to claim 26, and comprising fixedly coupling the projector to the hand-held camera.

28. A method according to claim 26, wherein focussing the marker pattern comprises focussing the marker pattern responsive to a marker-pattern depth-of-field, wherein capturing the image comprises focussing the camera on the region within a camera depth-of-field, and wherein the marker-pattern depth-of-field is a predetermined function of the camera depth-of-field.

29. A method according to claim 26, wherein focussing the marker pattern comprises focussing the marker pattern within a marker-pattern depth-of-field, wherein capturing the image comprises focussing the camera on the region within a camera depth-of-field, and wherein the marker-pattern depth-of-field is substantially the same as the camera depth-of-field.

30. A method according to claim 26, wherein the hand-held camera is comprised in a mobile telephone.

31. A method according to claim 26, wherein the projector comprises a mask and one or more illuminators and wherein projecting the marker pattern comprises projecting an image of the mask onto the object so as to form the marker pattern thereon.

32. A method according to claim 31, wherein projecting the marker pattern comprises adjusting a position of at least one of the mask and the one or more illuminators so as to generate a different marker pattern responsive to the adjustment.

33. A method according to claim 26, wherein projecting the marker pattern comprises projecting a plurality of elements having a predetermined relationship with each other, and wherein capturing the image comprises correcting a distortion of the image of the region utilizing a central processing unit (CPU) responsive to a captured image of the elements and the predetermined relationship.

34. A method according to claim 33, wherein the distortion comprises at least one distortion chosen from a group of distortions comprising translation, scaling, rotation, shear, and perspective.

35. A method according to claim 26, wherein the projector comprises one or more illuminators, wherein the hand-held camera comprises an imaging sensor, and wherein projecting the marker pattern comprises fixedly coupling the illuminators to the imaging sensor, and wherein focussing the marker pattern comprises focussing the pattern at a conjugate plane of the sensor.

36. A method according to claim 35, wherein the one or more illuminators comprise respective one or more mirrors which are implemented with the imaging sensor as one monolithic element, and wherein projecting the marker pattern comprises illuminating the one or more mirrors.

37. A method according to claim 36, wherein the one or more mirrors comprise diffractive optics.

38. A method according to claim 35, wherein the one or more illuminators comprise respective one or more holes which are implemented within the sensor and a source and a light guide, and wherein projecting the marker pattern comprises directing light from the source via the light guide through the one or more holes.

39. A method according to claim 35, and comprising measuring at least one parameter in a first group of parameters comprising an intensity of the marker pattern and an intensity of the image, and altering an intensity of the one or more illuminators responsive to at least one parameter of a second group of parameters comprising a distance of the object from the camera, the measured marker pattern intensity, and the measured image intensity.

40. A method according to claim 26, and comprising analyzing a position of an image of the marker pattern produced in the hand-held camera, and generating a sensory signal to a user of the apparatus responsive to the analyzed position of the marker pattern image relative to the image of the region.

41. A method according to claim 26, wherein the projector comprises a first and a second optical beam generator, and wherein the marker pattern comprises a respective first and second image of each beam on the object, and wherein focussing the marker pattern comprises aligning the first and second images to substantially coincide.

42. A method according to claim 26, wherein the camera comprises a CPU, and wherein capturing the image comprises determining a characteristic of the image of the region with the CPU, and wherein projecting the marker pattern comprises varying a position of the marker pattern with a beam director comprised in the projector responsive to a signal from the CPU and the characteristic of the image.

43. A method according to claim 42, wherein determining the characteristic of the image comprises:
analyzing the image of the region to recover text therein; and
determining a text characteristic of the text.

44. A method according to claim 26, wherein defining the region comprises relating a portion of the object to the marker pattern by a predetermined geometrical relationship.

45. A method according to claim 44, wherein relating a portion of the object comprises framing the portion by the marker pattern.
